(19) United States
(12) Patent Application Publication
(10) Pub. No.: US 2026/0122074 A1
(43) Pub. Date: Apr. 30, 2026

(54) SYSTEMS AND METHODS FOR DETERMINING JIT PERMISSIONS

(71) Applicant: Cisco Technology, Inc., San Jose, CA (US)

(72) Inventors: Yedidya Dotan, Newton, MA (US); Alex Zaslavsky, Newton, MA (US); Yana Vaisman, Netanya (IL); Yulia Nevler, Raanana (IL); Ben A. Murray, Ann Arbor, MI (US); Oded S. Peer, Raanana (IL)

(21) Appl. No.: 19/061,729

(22) Filed: Feb. 24, 2025

Related U.S. Application Data
(60) Provisional application No. 63/712,137, filed on Oct. 25, 2024.

(51) Int. Cl. H04L 9/40

(52) U.S. Cl. CPC H04L 63/105; H04L 63/20

(57) ABSTRACT

In an embodiment, a method includes determining recommended permissions for application access for a user based on the user's identity information within an organization and receiving a request from the user to access an application. The method also includes determining an operation that the user intends to perform with respect to the application based on the request, selecting a permission from the recommended permissions based on the application and the operation, granting the selected permission to the user, and determining that the operation with the respect to the application by the user is completed based on an analysis of activity data associated with the application. The method further includes revoking the permission to access the application by the user responsive to determining that the first operation is completed.

### PRIORITY

This application claims the benefit, under 35 U.S.C. § 119(e), of U.S. Provisional Patent Application No. 63/712137, filed Oct. 25, 2024, which is incorporated herein by reference.

### TECHNICAL FIELD This disclosure generally relates to security, and in particular relates to systems and methods for determining Just-In-Time (JIT) permissions.

### BACKGROUND

Certain identity intelligence engines currently provide an artificial intelligence (AI)-powered solution that bridges the gap between authentication and access. Identity and access management (IAM) is the practice of making sure that people and entities with digital identities have the right level of access to enterprise resources like networks and databases. User roles and access privileges are defined and managed through an IAM system. With an IAM system, businesses can apply the same security policies across the enterprise. IAM methods like single sign-on (SSO) and multi-factor authentication (MFA) reduce the risk that user credentials will be compromised or abused.

### BRIEF DESCRIPTION OF THE DRAWINGS

FIG. 1 illustrates a system for determining JIT permissions, in accordance with certain embodiments.

FIG. 2 illustrates a user interface (UI) displaying JIT rules for a JIT provisioning service, in accordance with certain embodiments.

FIG. 3 illustrates a UI displaying a JIT rule, in accordance with certain embodiments.

FIG. 4 illustrates a UI displaying another JIT rule, in accordance with certain embodiments.

FIG. 5 illustrates a UI displaying a web request, in accordance with certain embodiments.

FIGS. 6A-6B illustrate a flow diagram of a method for determining JIT permissions, in accordance with certain embodiments.

FIG. 7 illustrates an example computer system.

### DESCRIPTION OF EXAMPLE EMBODIMENTS

### Overview

According to an embodiment, a system may include one or more processors and one or more computer-readable non-transitory storage media comprising instructions that, when executed by the one or more processors, cause one or more components of the system to perform operations. The operations may include determining, for a first user based on identity information associated with the first user within an organization, a first set of recommended permissions for application access. The operations may also include receiving a first request from the first user to access a first application. The operations may additionally include determining, based on the first request, a first operation that the first user intends to perform with respect to the first application. The operations may also include selecting, based on the first application and the first operation, a first permission from the first set of recommended permissions. The operations may also include granting the first permission to the first user. The operations may additionally include determining, based on an analysis of activity data associated with the first application, that the first operation with the respect to the first application by the first user is completed. The operations may further include revoking the first permission to access the first application by the first user responsive to determining that the first operation is completed.

In certain embodiments, the identity information associated with the first user specifies one or more of a role of the first user within the organization or a rank of the first user within an organizational hierarchy of the organization.

In certain embodiments, the first application executes on a plurality of subsystems of an organization system associated with the organization.

In certain embodiments, the first operation includes at least a first sub-operation on a first subsystem of the plurality of subsystems and a second sub-operation on a second subsystem of the plurality of subsystems. The operations may further include accessing the activity data from at least the first and second subsystems. The operations may also include determining the first sub-operation on the first subsystem is completed based an analysis of the activity data from the first subsystem. The operations may additionally include determining the second sub-operation on the second subsystem is completed based an analysis of the activity data from the second subsystem. The operations may further include determining the first operation with respect to the first application by the first user is completed responsive to determining both the first and second sub-operations are completed.

In certain embodiments, the first subsystem and the second subsystem are linked.

In certain embodiments, the first sub-operation on the first subsystem requires the second sub-operation on the second subsystem. In addition, a completion of the first sub-operation on the first subsystem requires a completion of the second sub-operation on the second subsystem.

In certain embodiments, the organization system may include a secure identity cloud.

In certain embodiments, the operations may include receiving a second request from a second user to access the first application. The operations may also include determining, based on the second request, a second operation that the second user intends to perform with respect to the first application. The operations may additionally include selecting, based on the first application and the second operation, a second permission from a second set of recommended permissions associated with the second user. The second set of recommended permissions are determined based on identity information associated with the second user within an organization. The operations may further include granting a second permission to the second user. The first permission and the second permission are configured to enable the first operation by the first user and the second operation by the second user simultaneously without interrupting each other.

According to another embodiment, a method may include determining, for a first user based on identity information associated with the first user within an organization, a first set of recommended permissions for application access. The method may also include receiving a first request from the first user to access a first application. The method may additionally include determining, based on the first request, a first operation that the first user intends to perform with respect to the first application. The method may also include selecting, based on the first application and the first operation, a first permission from the first set of recommended permissions. The method may also include granting the first permission to the first user. The method may additionally include determining, based on an analysis of activity data associated with the first application, that the first operation with the respect to the first application by the first user is completed. The method may further include revoking the first permission to access the first application by the first user responsive to determining that the first operation is completed.

According to yet another embodiment, one or more computer-readable non-transitory storage media may embody instructions that, when executed by a processor, cause the performance of operations. The operations may include determining, for a first user based on identity information associated with the first user within an organization, a first set of recommended permissions for application access. The operations may also include receiving a first request from the first user to access a first application. The operations may additionally include determining, based on the first request, a first operation that the first user intends to perform with respect to the first application. The operations may also include selecting, based on the first application and the first operation, a first permission from the first set of recommended permissions. The operations may also include granting the first permission to the first user. The operations may additionally include determining, based on an analysis of activity data associated with the first application, that the first operation with the respect to the first application by the first user is completed. The operations may further include revoking the first permission to access the first application by the first user responsive to determining that the first operation is completed.

Technical advantages of certain embodiments of this disclosure may include one or more of the following. The disclosed system and method can integrate JIT permission management as part of the regular working process of an organization using its information technology service management (ITSM) systems and source control systems, which can facilitate least privilege attestations and make compliance easier to achieve. The disclosed system and method can reduce the risk of administrative credential loss. The disclosed system and method can provide automated permission management, comprehensive compliance reporting, and a user-friendly interface.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

In today's digital landscape, SSO adoption is on the rise, presenting a unique opportunity to reduce the number of super user accounts within organizations. As a result, many companies are revamping their privileged access management (PAM) services to incorporate JIT access for real users instead of relying on permanent super user accounts. This shift not only enhances security but also aligns with the principle of least privilege.

In certain embodiments, a security system can adaptively grant JIT permissions to a user based on the identity information associated with the user when the user requests to access applications associated with an organization. For example, the identity information may include the user's role or rank within the organization. The security system may access a pre-generated list of recommended permissions (e.g., generated based on the identity information) for the user. The security system may select one or more recommended permissions from the list based on what operations the user intends to perform on the application. The security system may grant the JIT permissions and then actively monitor the user's operation. Once the operation is completed, the security system may revoke the granted JIT permissions.

In certain embodiments, the security system may provision JIT permission service as an identity intelligence. The JIT permissions service can be strategically positioned to offer an innovative solution that seamlessly integrates with existing ITSM and source control systems. This integration can ensure that users can have the benefits of JIT permissions as part of their everyday workflows, simplifying compliance processes and reducing the risk associated with administrative credential loss. By providing a console-less solution, the disclosed system and method can enhance user retention by integrating deeply into their workflows. The deep integration can enable an organization to capture a larger share of the identity management budget, further solidifying its market position.

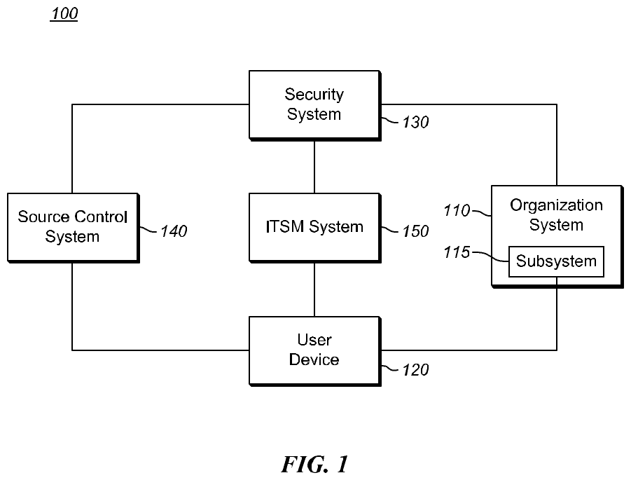

FIG. 1 illustrates an example system 100 for determining JIT permissions, in accordance with certain embodiments. System 100 may include an organization system 110 associated with an organization which includes a subsystem 115, a user device 120, a security system 130, a source control system 140, and an ITSM system 150. Although FIG. 1 illustrates one organization system 110 including one subsystem 115, one user device 120, one security system 130, one source control system 140, and one ITSM system 150, this disclosure contemplates any suitable number of organization systems 110 including any suitable number of subsystems 115, user devices 120, security systems 130, source control systems 140, and ITSM systems 150. For example, there may be two or more subsystems 115 in organization system 110.

In certain embodiments, the organization system 110 may be a security identity cloud. As an example and not by way of limitation, the secure identity cloud may be an identity and/or access management company that provides cloud software (e.g., Okta). The organization system 110 may include one or more subsystems 115 where applications are hosted. A user, e.g., an employer of the organization, may use a user device 120 to access subsystem 115 of organization system 110, given JIT permissions are granted to the user. The user device 120 may be a computer, a smartphone, a tablet, a laptop, a wearable device, or any other suitable type of device for communicating with other components of system 100.

In certain embodiments, the security system 130 may integrate with the source control system 140 and the ITSM system 150. In certain embodiments, the source control system 140 is a version control system designed to track changes in source code and/or other text files during software development. The source control system 140 may be one of the following: GitHub, GitLab, or Bitbucket. A user may, via their user device 120, open an issue in the source control system 140 (e.g., GitHub) to request a JIT permission. Integration with source control systems 140 can allow users to request permissions via issues in platforms such as GitHub, GitLab, or Bitbucket.

In certain embodiments, the ITSM system is a set of tools, policies, and/or processes that IT teams use to manage the delivery of IT services to customers. Integration with ITSM systems 150 can ensure seamless compatibility with existing ITSM systems 150 (e.g., ServiceNow and Jira). For example, ServiceNow is a comprehensive ITSM system 150 that automates enterprise IT operations, including service requests, incident management, and change management. ServiceNow can be tightly integrated with organizational workflows and contain the definition of permission escalation policies. For instance, users requiring access to Okta's super administrative role may need to specify the issue they are solving. This request may be then reviewed to determine whether the action should be approved. ServiceNow may be used to review and audit past escalations to determine if access was legitimate.

As another example, Jira is an ITSM system 150 designed for issue and project tracking, enabling agile project management and IT service desk operations. Jira can integrate tightly with organizational workflows and define permission escalation policies like ServiceNow, ensuring proper review and audit processes.

The JIT permission service provisioned by the security system 130 can integrate seamlessly with ITSM systems 150 and source control systems 140, thereby simplifying compliance, reducing risk, and enhancing security.

The security system 130 of system 100 may be computer hardware and/or software (e.g., a computer program) that provides security-related services to organization system 110, such as determining recommended permissions for users based on their identities, determining JIT permissions, granting JIT permissions, monitoring user activities on the subsystem 115, and/or revoking JIT permissions. In certain embodiments, the security system 130 accesses a variety of system signals from subsystem 115. The security system 130 may use the accessed subsystem signals to determine the status of the user's operation on the application.

In certain embodiments, the security system 130 may add a user to a group within a JIT provisioning platform. The security system 130 may create an issue in a source control system 140. The security system 130 may then assign the issue to the user. The security system 130 may assign a first status to the issue. In some embodiments, the first status is in progress. The security system 130 may trigger the issue to the JIT provisioning platform from the source control system 140. The security system 130 may grant the user permissions to an organization system (e.g., a secure identity cloud) associated with the issue by adding the user as a member of a JIT access group. The security system 130 may change the status of the issue from the first status to a second status. In some embodiments, the second status is done. The security system 130 may trigger the status update to the JIT provisioning platform. The security system 130 may further revoke the user's permission to the secure identity cloud associated with the issue by removing the user as a member of the JIT access member group.

In certain embodiments, to accurately determining the status of the user's operation, the security system 130 may refresh the user's data (e.g., signals from the subsystem 115) in the JIT access platform, which re-fetches the user's data from the secure identity cloud.

In certain embodiments, the user's operation on an application may involve multiple subsystems 115 as the application may execute on these multiple subsystems 115 and the user's operation on one subsystem 115 may require an associated operation on another one or more subsystems 115 (e.g., the completion of the operation on one subsystem 115 requires a completion of the operation(s) on the other one or more subsystems 115). These subsystems 115 may be linked. In some embodiments, these subsystems 115 may be linked in an escalated manner. For example, the user's operation may include a first sub-operation on a first subsystem 115 and a second sub-operation on a second subsystem 115. To accurately determine the status of the user's operation, the security system 130 may access the activity data derived from the signals from the first and second subsystems 115. The security system 130 may determine the first sub-operation on the first subsystem 115 is completed based an analysis of the activity data from the first subsystem 115 and the second sub-operation on the second subsystem 115 is completed based an analysis of the activity data from the second subsystem 115. The security system 115 may further determine the user's operation with respect to the application is completed responsive to determining both the first and second sub-operations are completed.

An end-to-end process of an embodiment is described as follows for demonstration purposes. In this use case, a user opens an issue in a source control system (e.g., GitHub) to request a permission (e.g., a role in a cloud service). When a status of the issue is marked as in progress (e.g., ‘Work in Progress’), JIT permission is granted. When the status of the issue is marked as closed (e.g., marked as ‘Done’), the JIT permission is revoked.

In certain embodiments, the security system 130 may grant JIT permissions to multiple users who intend to work on the same application. As each user's recommended permissions and intended operation may be specific to that user, the granted JIT permissions may not lead to conflict between the operations of the users. In other words, each user with their own granted permissions can perform their intended operations without interrupting each other.

In certain embodiments, the security system 130 may use automated permission management. Automated permission management may include issue-based permission granting, where permissions are automatically granted when an issue is in progress (e.g., ‘In Progress’ or ‘Work in Progress’). Automated permission management may include issue-based permission revocation, where permissions are automatically revoked when the issue is closed (e.g., ‘Done’). This automation can ensure that permissions are only active when needed, adhering to the principle of least privilege.

In certain embodiments, the JIT provisioning service by the security system 130 may include compliance and reporting. The JIT provisioning service may simplify compliance reporting with automated least privilege attestations and provide comprehensive logging and reporting for compliance and audit purposes. The JIT provisioning service may ensure that organizations can easily demonstrate compliance with regulatory requirements and internal policies.

In some embodiments, the JIT provisioning service by the security system 130 may include an intuitive UI for requesting and managing permissions, ensuring that users can easily navigate the system. Real-time notifications may be used to inform users of permission status changes, enhancing transparency and efficiency.

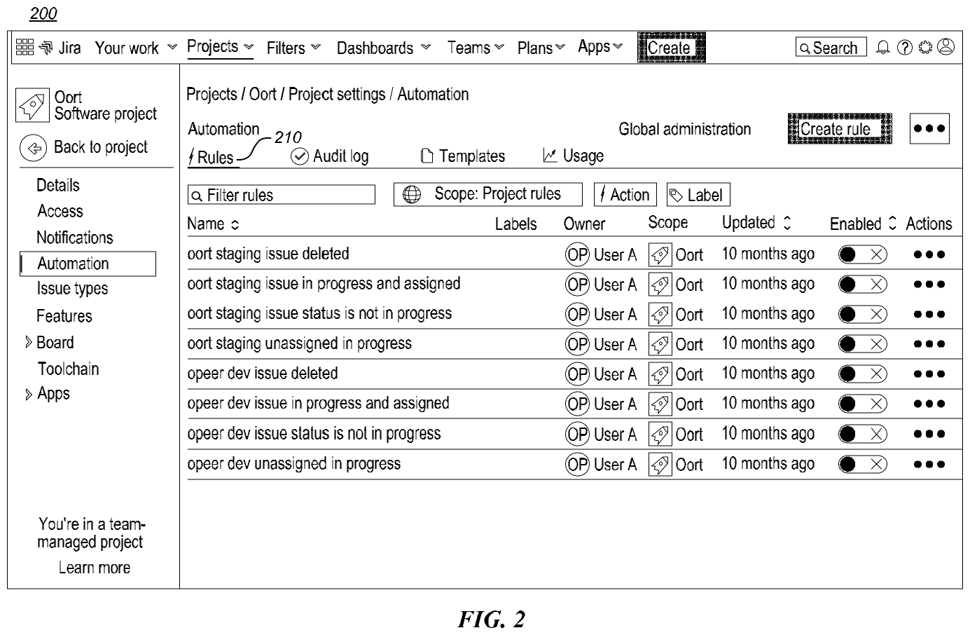

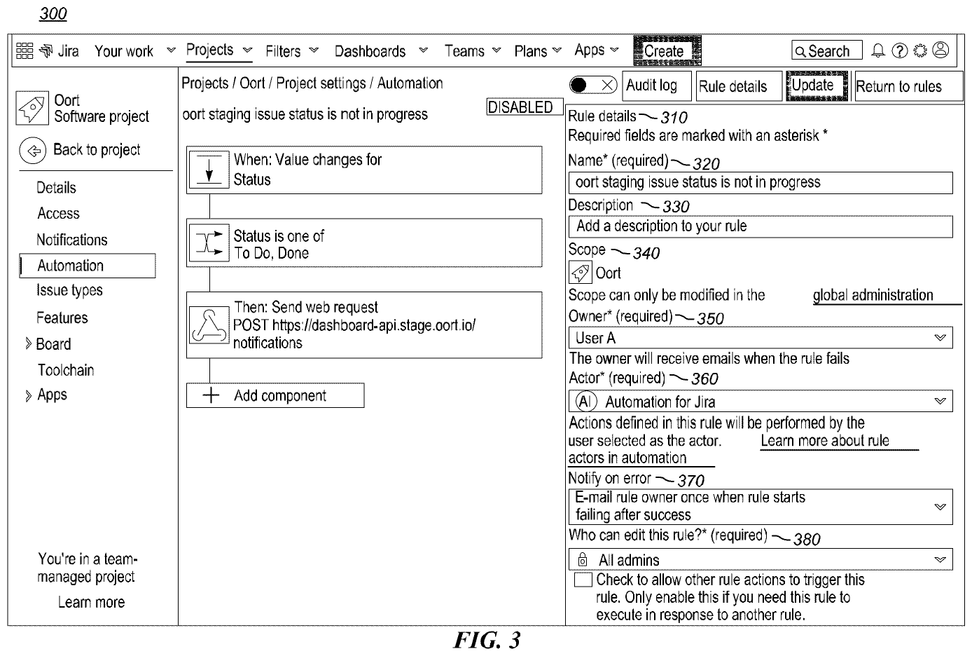

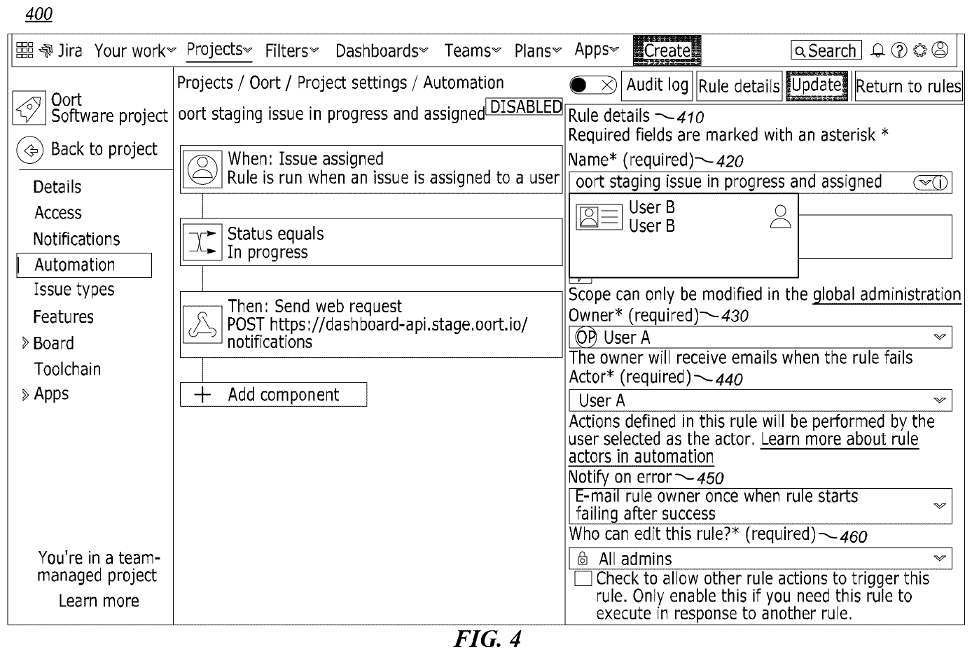

FIG. 2 illustrates a UI 200 displaying JIT rules of the JIT provisioning service, in accordance with certain embodiments. In the illustrated embodiment of FIG. 2, the rules 210 include the following: ‘oort staging issue deleted’; ‘oort staging issue in progress and assigned’; ‘oort staging issue stats us not in progress’; ‘opeer dev issue deleted’; ‘opeer dev issue in progress and assigned’; ‘opeer dev issue status is not in progress’; and ‘opeer dev unassigned in progress’. Although FIG. 1 illustrates a UI for an identity-centric enterprise security platform (Oort), this disclosure contemplates any suitable UI for any suitable security platform. The JIT rules 210 are described in more detail with reference to FIGS. 3-4 below.

In certain embodiments, the JIT provisioning service may be provided access to workflows in an ITSM system 150 such as Jira. In an example use case, User A is added to a group within the JIT provisioning service. User A then creates an issue in the ITSM system 150, changes the status of the issue to ‘In Progress’, and assigns the issue to User A. In the JIT provisioning service, the system log section of dashboard may show the successful result of the event triggered from the ITSM system 150. In User A's profile, User A can refresh the user data, which re-fetches the data from the organization system 110 (e.g., Okta). User A is now a member of the group for JIT access. User A then moves the issue to ‘Done’ in the ITSM system 150. In the JIT access platform, the system log section of dashboard may show the successful result of the event triggered from the ITSM system 150. In User A's profile, User A can refresh the user data, which re-fetches the data from the organization system 110 (e.g., Okta). User A's profile may now confirm that User A is no longer a member of the JIT access member group.

FIG. 3 illustrates a UI 300 displaying a JIT rule, in accordance with certain embodiments. The following rule details 310 may be input into the UI 300, as shown in FIG. 3: the name 320 of the rule (e.g., oort staging issue status is not in progress); a description 330 of the rule; a scope 340 of the rule; an owner 350 of the rule (e.g., User A); an actor 360 (e.g., Automation for Jira); a notify on error 370 (e.g., E-mail rule owner once when rule starts failing after success); and a list of users/groups that can edit this rule 380 (e.g., All admins).

In certain embodiments, the input of one or more rule details 310 (e.g., the name 320 of the rule, the owner 350 of the rule, the actor 360, and the users/groups that can edit the rule 380) may be required, whereas the input of one or more other rule details 310 may be optional. In some embodiments, the owner 350 will receive emails when the rule fails. The actions defined in the rule may be performed by the user selected as the actor 360. In certain embodiments, the user may check a box to allow other rule actions to trigger this rule. The user may enable this feature if the user wants/needs this rule to execute in response to another rule.

The following action may be associated with the rule illustrated in FIG. 3: When value changes for ‘Status’, and the status is one of ‘To Do’ or ‘Done’, then send web request to dashboard API notifications.

FIG. 4 illustrates a UI 400 displaying another JIT rule, in accordance with certain embodiments. The following rule details 410 may be input into the UI 400, as shown in FIG. 4: the name 420 of the rule (e.g., oort staging issue in progress and assigned); a description of the rule (not shown); a scope of the rule (not shown); an owner 430 of the rule (e.g., User A); an actor 440 (e.g., Automation for Jira); a notify on error 450 (e.g., E-mail rule owner once when rule starts failing after success); and a list of users/groups that can edit this rule 460 (e.g., All admins).

In certain embodiments, the input of one or more rule details 410 (e.g., the name 420 of the rule, the owner 430 of the rule, the actor, and the users/groups that can edit the rule 460) may be required, whereas the input of one or more other rule details 410 may be optional. In some embodiments, the owner 430 will receive emails when the rule fails. The actions defined in the rule may be performed by the user selected as the actor 440. In certain embodiments, the user may check a box to allow other rule actions to trigger this rule. The user may enable this feature if the user wants/needs this rule to execute in response to another rule.

The following actions may be associated with the rule illustrated in FIG. 4: When the issue is assigned to a user, the rule is run. When the status equals ‘In Progress’, then send web request to dashboard API notifications. In certain embodiments, the web request is a Hypertext Transfer Protocol (HTTP) request to the Uniform Resource Locator (URL) specified.

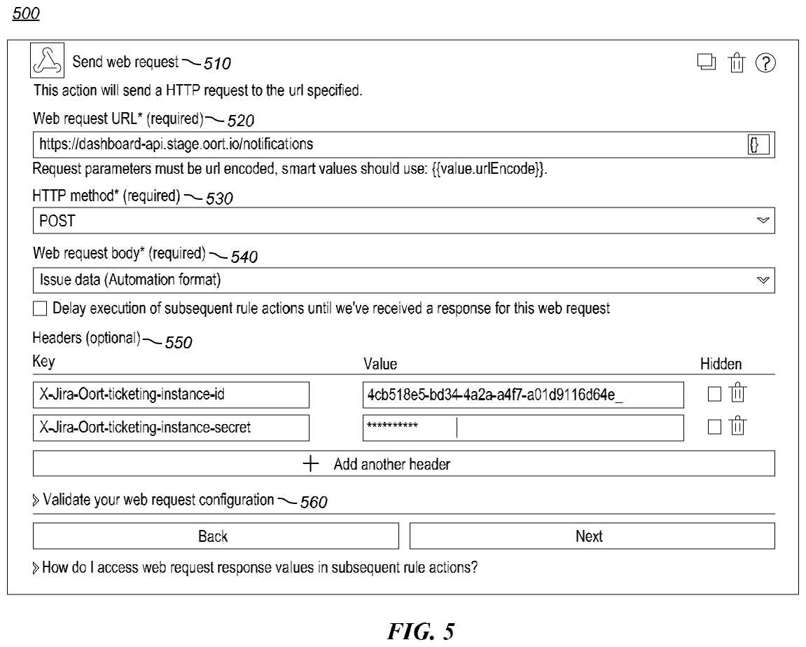

FIG. 5 illustrates a UI 500 displaying a web request, in accordance with certain embodiments. The web request action 510, as illustrated in FIG. 5, may send an HTTP request to the URL specified. The request parameters may be URL encoded. In the illustrated embodiment of FIG. 5, the user enters the following information for the web request: the web request URL 520, the HTTP method 530 (e.g., POST), the web request body 540 (e.g., Issue data (Automation format)), headers 550 (e.g., Keys and Values), and a validate web request configuration selection 560 (e.g., Back/Next).

In certain embodiments, one or more user inputs may be required, such as the web request URL 520, the HTTP method 530, and the web request body 540. In some embodiments, one or more user inputs may be optional, such as the headers 550. The headers 550 may include an option (e.g., a check box) to be hidden or deleted.

In some embodiments, the web request may include an option (e.g., a check box) to delay execution of subsequent rule actions until a response is received from the web request. In certain embodiments, the UI 500 may provide information on how to access web request response values in subsequent rule actions.

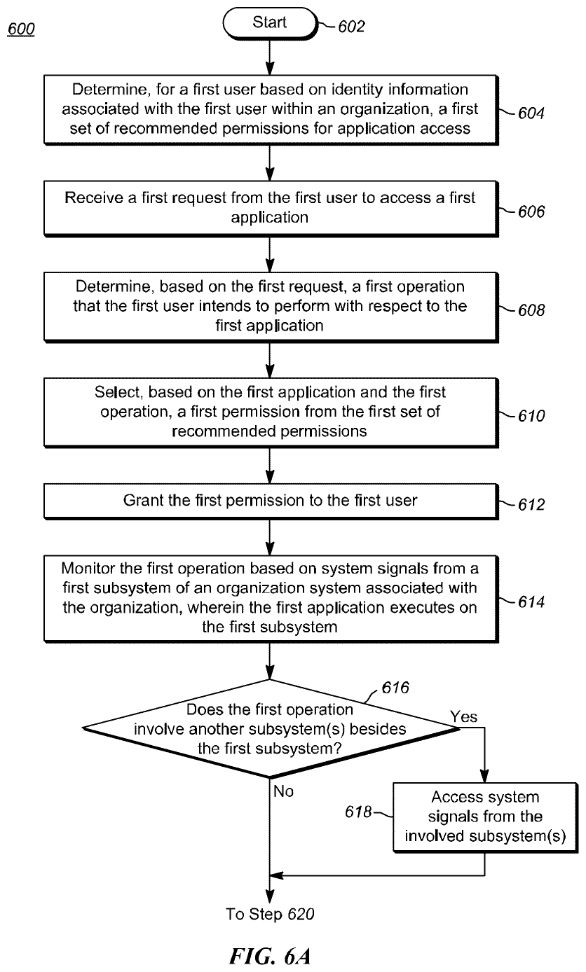

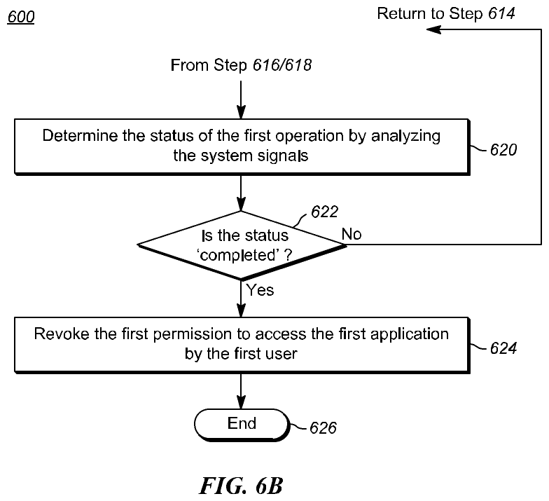

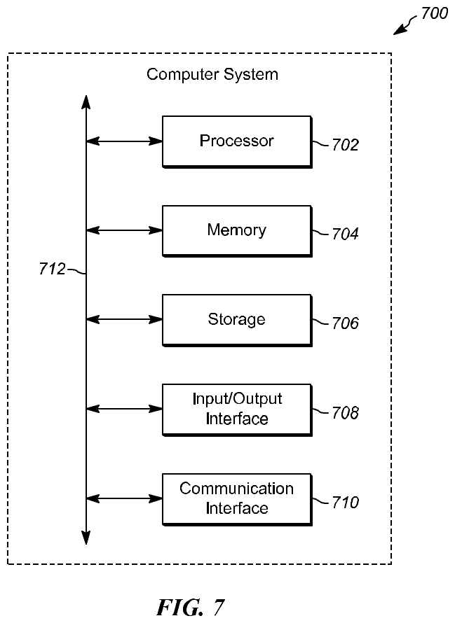

FIGS. 6A-6B illustrate a flow diagram of a method 600 for determining JIT permissions, in accordance with certain embodiments. In an embodiment, the steps of method 600 may be performed by a security system 130. More specifically, the steps of method 600 may be performed by one or more components of the computer system of FIG. 7. The method may start at step 602.

At step 604, the security system 130 may determine, for a first user based on identity information associated with the first user within an organization, a first set of recommended permissions for application access. In certain embodiments, the identity information may specify one or more of a role of the first user within the organization or a rank of the first user within an organizational hierarchy of the organization.

At step 606, the security system 130 may receive a first request from the first user to access a first application. In certain embodiments, the first request may be received via a source control system 140 or an ITSM system 150.

At step 608, the security system 130 may determine, based on the first request, a first operation that the first user intends to perform with respect to the first application.

At step 610, the security system 130 may select, based on the first application and the first operation, a first permission from the first set of recommended permissions.

At step 612, the security system 130 may grant the first permission to the first user.

At step 614, the security system 130 may monitor the first operation based on system signals from a first subsystem 115 of an organization system 110 associated with the organization. The first application may execute on the first subsystem.

At step 616, the security system 130 may determine whether the first operation involves another one or more subsystem(s) 115 besides the first subsystem 115. If there are no other subsystem(s) 115 involved, method 600 may proceed to step 620.

If there are other subsystem(s) involved, the security system 130 may access system signals from theses involved subsystem(s) 115 at step 618. Method 600 may then proceed to step 620.

At step 620, the security system 130 may determine the status of the first operation by analyzing the system signals from the first subsystem 115 (and other involved subsystem(s) 115, if any). For example, the status may be ‘in progress’or ‘completed’.

At step 622, the security system 130 may determine whether the status is ‘completed’. If the status is not ‘completed’, method 600 may return to step 614. The security system 130 may continue monitoring the subsystem signals from the first subsystem 115 (and other involved subsystem(s) 115, if any), analyzing the subsystem signals, and determining the status of the first operation.

If the status is ‘completed’, method 600 may proceed to step 624, where the security system 130 may revoke the first permission to access the first application by the first user.

At step 626, the method may end.

Although this disclosure describes and illustrates particular steps of method 600 of FIGS. 6A-6B as occurring in a particular order, this disclosure contemplates any suitable steps of method 600 of FIGS. 6A-6B occurring in any suitable order. Although this disclosure describes and illustrates an example method for determining JIT permissions including the particular steps of method 600 of FIGS. 6A-6B, this disclosure contemplates any suitable method for determining JIT permissions including any suitable steps, which may include all, some, or none of the steps of method 600 of FIGS. 6A-6B, where appropriate. Furthermore, although FIGS. 6A-6B describe and illustrate particular components, devices, or systems carrying out particular actions, this disclosure contemplates any suitable combination of any suitable components, devices, or systems carrying out any suitable actions.

FIG. 7 illustrates an example computer system 700. In particular embodiments, one or more computer system 700 perform one or more steps of one or more methods described or illustrated herein. In particular embodiments, one or more computer system 700 provide functionality described or illustrated herein. In particular embodiments, software running on one or more computer system 700 performs one or more steps of one or more methods described or illustrated herein or provides functionality described or illustrated herein. Particular embodiments include one or more portions of one or more computer system 700. Herein, reference to a computer system may encompass a computing device, and vice versa, where appropriate. Moreover, reference to a computer system may encompass one or more computer systems, where appropriate.

This disclosure contemplates any suitable number of computer system 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer system 700; be unitary or distributed; span multiple locations; span multiple machines; span multiple data centers; or reside in a cloud, which may include one or more cloud components in one or more networks. Where appropriate, one or more computer system 700 may perform without substantial spatial or temporal limitation one or more steps of one or more methods described or illustrated herein. As an example, and not by way of limitation, one or more computer system 700 may perform in real time or in batch mode one or more steps of one or more methods described or illustrated herein. One or more computer system 700 may perform at different times or at different locations one or more steps of one or more methods described or illustrated herein, where appropriate.

In particular embodiments, computer system 700 includes a processor 702, a memory 704, a storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer system 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments disclosed herein include a method, an apparatus, a storage medium, a system and a computer program product, wherein any feature mentioned in one category, e.g., a method, can be applied in another category, e.g., a system, as well.

What is claimed is:

1. A system, comprising:
one or more processors; and
one or more computer-readable non-transitory storage media comprising instructions that, when executed by the one or more processors, cause one or more components of system to perform operations comprising:
determining, for a first user based on identity information associated with the first user within an organization, a first set of recommended permissions for application access;
receiving a first request from the first user to access a first application;
determining, based on the first request, a first operation that the first user intends to perform with respect to the first application;
selecting, based on the first application and the first operation, a first permission from the first set of recommended permissions;
granting the first permission to the first user;
determining, based on an analysis of activity data associated with the first application, that the first operation with the respect to the first application by the first user is completed; and
responsive to determining that the first operation is completed, revoking the first permission to access the first application by the first user.

2. The system of claim 1, wherein the identity information associated with the first user specifies one or more of a role of the first user within the organization or a rank of the first user within an organizational hierarchy of the organization.

3. The system of claim 1, wherein the first application executes on a plurality of subsystems of an organization system associated with the organization.

4. The system of claim 3, wherein the first operation comprises at least a first sub-operation on a first subsystem of the plurality of subsystems and a second sub-operation on a second subsystem of the plurality of subsystems, the operations further comprising:
accessing the activity data from at least the first and second subsystems;
determining the first sub-operation on the first subsystem is completed based an analysis of the activity data from the first subsystem;
determining the second sub-operation on the second subsystem is completed based an analysis of the activity data from the second subsystem; and
determining the first operation with respect to the first application by the first user is completed responsive to determining both the first and second sub-operations are completed.

5. The system of claim 4, where the first subsystem and the second subsystem are linked.

6. The system of claim 4, where the first sub-operation on the first subsystem requires the second sub-operation on the second subsystem, and wherein a completion of the first sub-operation on the first subsystem requires a completion of the second sub-operation on the second subsystem.

7. The system of claim 3, where the organization system comprises a secure identity cloud.

8. The system of claim 1, the operations further comprising:
receiving a second request from a second user to access the first application;
determining, based on the second request, a second operation that the second user intends to perform with respect to the first application;
selecting, based on the first application and the second operation, a second permission from a second set of recommended permissions associated with the second user, wherein the second set of recommended permissions are determined based on identity information associated with the second user within an organization; and
granting a second permission to the second user;
wherein the first permission and the second permission are configured to enable the first operation by the first user and the second operation by the second user simultaneously without interrupting each other.

9. A method, comprising:
determining, for a first user based on identity information associated with the first user within an organization, a first set of recommended permissions for application access;
receiving a first request from the first user to access a first application;
determining, based on the first request, a first operation that the first user intends to perform with respect to the first application;
selecting, based on the first application and the first operation, a first permission from the first set of recommended permissions;
granting the first permission to the first user;
determining, based on an analysis of activity data associated with the first application, that the first operation with the respect to the first application by the first user is completed; and
responsive to determining that the first operation is completed, revoking the first permission to access the first application by the first user.

10. The method of claim 9, wherein the identity information associated with the first user specifies one or more of a role of the first user within the organization or a rank of the first user within an organizational hierarchy of the organization.

11. The method of claim 9, wherein the first application executes on a plurality of subsystems of an organization system associated with the organization.

12. The method of claim 11, wherein the first operation comprises at least a first sub-operation on a first subsystem of the plurality of subsystems and a second sub-operation on a second subsystem of the plurality of subsystems, the method further comprising:
accessing the activity data from at least the first and second subsystems;
determining the first sub-operation on the first subsystem is completed based an analysis of the activity data from the first subsystem;
determining the second sub-operation on the second subsystem is completed based an analysis of the activity data from the second subsystem; and
determining the first operation with respect to the first application by the first user is completed responsive to determining both the first and second sub-operations are completed.

13. The method of claim 12, where the first subsystem and the second subsystem are linked.

14. The method of claim 12, where the first sub-operation on the first subsystem requires the second sub-operation on the second subsystem, and wherein a completion of the first sub-operation on the first subsystem requires a completion of the second sub-operation on the second subsystem.

15. The method of claim 9, further comprising:
receiving a second request from a second user to access the first application;
determining, based on the second request, a second operation that the second user intends to perform with respect to the first application;
selecting, based on the first application and the second operation, a second permission from a second set of recommended permissions associated with the second user, wherein the second set of recommended permissions are determined based on identity information associated with the second user within an organization; and
granting a second permission to the second user;
wherein the first permission and the second permission are configured to enable the first operation by the first user and the second operation by the second user simultaneously without interrupting each other.

16. A non-transitory computer-readable medium comprising instructions that are configured, when executed by a processor, to:
determine, for a first user based on identity information associated with the first user within an organization, a first set of recommended permissions for application access;
receive a first request from the first user to access a first application;
determine, based on the first request, a first operation that the first user intends to perform with respect to the first application;
select, based on the first application and the first operation, a first permission from the first set of recommended permissions;
grant the first permission to the first user;
determine, based on an analysis of activity data associated with the first application, that the first operation with the respect to the first application by the first user is completed; and
responsive to determining that the first operation is completed, revoke the first permission to access the first application by the first user.

17. The non-transitory computer-readable medium of claim 16, wherein the identity information associated with the first user specifies one or more of a role of the first user within the organization or a rank of the first user within an organizational hierarchy of the organization.

18. The non-transitory computer-readable medium of claim 16, wherein the first application executes on a plurality of subsystems of an organization system associated with the organization.

19. The non-transitory computer-readable medium of claim 18, wherein the first operation comprises at least a first sub-operation on a first subsystem of the plurality of subsystems and a second sub-operation on a second subsystem of the plurality of subsystems, the medium further comprising instructions that are configured, when executed by a processor, to:
access the activity data from at least the first and second subsystems;
determine the first sub-operation on the first subsystem is completed based an analysis of the activity data from the first subsystem;
determine the second sub-operation on the second subsystem is completed based an analysis of the activity data from the second subsystem; and
determine the first operation with respect to the first application by the first user is completed responsive to determining both the first and second sub-operations are completed.

20. The non-transitory computer-readable medium of claim 16, further comprising instructions that are configured, when executed by a processor, to:
receive a second request from a second user to access the first application;
determine, based on the second request, a second operation that the second user intends to perform with respect to the first application;
select, based on the first application and the second operation, a second permission from a second set of recommended permissions associated with the second user, wherein the second set of recommended permissions are determined based on identity information associated with the second user within an organization; and
grant a second permission to the second user;
wherein the first permission and the second permission are configured to enable the first operation by the first user and the second operation by the second user simultaneously without interrupting each other.
